(19) United States
(12) Patent Application Publication
(10) Pub. No.: US 2015/0134249 A1
(43) Pub. Date: May 14, 2015

(54) WEARABLE ELECTRONIC DEVICE

(71) Applicant: Wei-Chi Yen, Taipei City (TW)

(72) Inventor: Wei-Chi Yen, Taipei City (TW)

(73) Assignee: ASUSTEK COMPUTER INC., Taipei City (TW)

(21) Appl. No.: 14/537,871

(22) Filed: Nov. 10, 2014

Related U.S. Application Data
(60) Provisional application No. 61/902,299, filed on Nov. 11, 2013.

(51) Int. Cl. G01C 21/00

(52) U.S. Cl. CPC G01C 21/00
USPC 701/541

(57) ABSTRACT

A wearable electronic device is provided. The wearable electronic device includes a gravity sensor, a processor and an input/output module. The gravity sensor is used for sensing a moving direction of the wearable electronic device. The gravity sensor and the input/output module are electrically connected to the processor, respectively. The processor generates navigation information according to the moving direction. The input/output module displays the navigation information.

### CROSS-REFERENCE TO RELATED APPLICATION

This application claims the priority benefit of U.S. provisional application Ser. No. 61/902,299, filed on Nov. 11, 2013. The entirety of the above-mentioned patent application is hereby incorporated by reference herein and made a part of specification.

### BACKGROUND OF THE INVENTION

1. Field of the Invention

The invention relates to an electronic device and, more particularly, to a wearable electronic device.

2. Description of the Related Art

Driving or visiting some places unfamiliar may requires a direction guiding or a map. With the popularity of the personal mobile devices and Global Position System (GPS), an electronic device equipped with a navigation function is launched, which is rather convenient for direction guiding while driving or moving forward while traveling.

In the beginning, the electronic device with GPS is mainly used for navigating and locating for vehicles, such as a car, a ship and an airplane. Nowadays, people take electronic devices with GPS while travelling for more correct positioning. The electronic device may pre-install navigation software and store map information of different regions, and an electronic map of the present area is showed on the display of the electronic device while driving, and then a driver would not get lost when visiting some places unfamiliar. However, a conventional electronic device with a navigation function usually occupies a large volume, which is not portable.

The conventional electronic device with a navigation function, such as a navigator, is usually disposed in a car. To facilitate watching navigation information more clear while driving, a larger-sized screen is equipped with the navigator, which occupancies large space and increases weight. Additionally, when the electronic device is fixed at a car, a position between the user and the electronic device changes less. However, when the electronic device is detached and carried out of the car, the user may misjudge the navigation information due to the change of the position, not to mention the inconvenience of holding the electronic device in hands.

### BRIEF SUMMARY OF THE INVENTION

A wearable electronic device is provided. The wearable electronic device provides a navigation function, where an angle and a direction of the first navigation information or the second navigation information are converted to the navigation information according to the gesture or the position of the user who wears it.

The wearable electronic device includes a gravity sensor, a processor and an input/output module. The gravity sensor is used for sensing a moving direction of the wearable electronic device. The processor is electrically connected to the gravity sensor and generates navigation information according to the moving direction. The input/output module is electrically connected to the processor to display the navigation information.

In an embodiment, the wearable electronic device further includes a storage unit electrically connected to the processor. The storage unit stores the first navigation information, wherein the navigation information is converted from the first navigation information.

In an embodiment, the wearable electronic device further includes a first wireless transmission module, a second navigation information stored in the electronic device is transmitted to the wearable electronic device via the first wireless transmission module, wherein the navigation information is converted from the second navigation information.

When the gravity sensor of the wearable electronic device senses the moving direction, the processor converts the first navigation information or the second navigation information to the navigation information according to the moving direction.

In an embodiment, the wearable electronic device further includes a light sensor sensing ambient light around the input/output module.

In an embodiment, when the input/output module is automatically turned off under low ambient light, the navigation information is generated in intermission, when the light sensor senses sufficiency ambient light, the input/output module is automatically turned on and displays latest navigation information. In an embodiment, low ambient light means that the ambient light is insufficient to read the information on the input/output module, the level of low ambient light is not limited herein.

As stated above, the gravity sensor can sense the moving direction of the wearable electronic device. The processor can tilts the angle of the first navigation information or the second navigation information to navigation information according to the moving direction, and thus the user can receive a right navigation direction even the user changes the gesture.

In order to facilitate understanding, the disclosure is illustrated with embodiments and accompanying figures.

### BRIEF DESCRIPTION OF THE DRAWINGS

FIG. 1A is a schematic diagram showing a wearable electronic device in an embodiment;

FIG. 1B is a schematic diagram showing that an input/output module of the wearable electronic device in FIG. 1A displays navigation information in an embodiment;

FIG. 1C is a schematic diagram with another view of FIG. 1B;

FIG. 2 is a schematic diagram showing a wearable electronic device in an embodiment;

FIG. 3 is a schematic diagram showing a wearable electronic device in an embodiment; and

FIG. 4 is a schematic diagram showing a wearable electronic device in an embodiment.

### DETAILED DESCRIPTION OF THE EMBODIMENTS

A wearable electronic device with a navigation function is illustrated in the following embodiments. A tilting angle of the navigation information is automatically adjusted and shows on the wearable electronic device, so as to reduce misjudges of the navigation information.

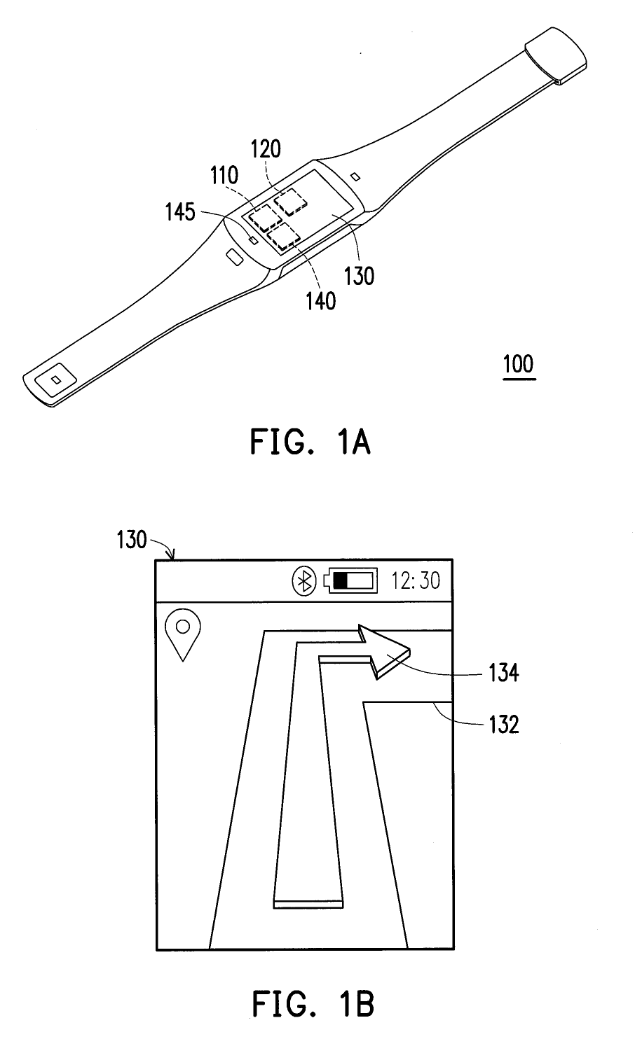

FIG. 1A is a schematic diagram showing a wearable electronic device in an embodiment. Please refer to FIG. 1, the wearable electronic device 100 includes a gravity sensor 110, a processor 120, an input/output module 130 and a storage unit 140. In the embodiment, the wearable electronic device 100 is a watch as an example, in other embodiments, the wearable electronic device 100 also may be a wristband, a pair of glasses or a necklace, which is not limited herein.

In the embodiment, the wearable electronic device 100 is smaller (such as the size of a watch) than a conventional electronic device (such as a navigator) with a navigation function. The wearable electronic device 100 also includes a navigation function except for the time display function. In detail, the gravity sensor 110, the input/output module 130 and the storage unit 140 are electrically connected to the processor 120, respectively.

In first embodiment, the storage unit 140 stores the navigation information with a first navigation information, when the navigation function of the wearable electronic device 100 is enabled, the wearable electronic device 100 can locate a current position, plan related navigation information according to a destination, and further display the navigation information on the input/output module 130.

The input/output module 130 is a screen as an example. FIG. 1B is a schematic diagram showing that an input/output module of the wearable electronic device in FIG. 1A displays navigation information in an embodiment. Please refer to FIG. 1B, in the embodiment, the navigation information includes map information 132 and directing information, which is not limited herein. The directing information is converted to an indication sign 134 (such as an arrow) by the processor 120, the map information 132 and the indication sign 134 can simultaneously be displayed on the input/output module 130.

Due to the limitation of the size of the input/output module 130 of the wearable electronic device 100, the map information 132 displayed on the input/output module 130 can only include main roads or neighboring roads information of the current position instead of map information in a large region. Additionally, the wearable electronic device 100 locates the position of the user at any time and synchronously updates roads displayed on the screen. In other words, the map information 132 displayed on the input/output module 130 is updated with the change of the position of the user. After a turn, a direction of a road displayed on the input/output module 130 is changed with the angle of the user.

A position and a moving direction of the wearable electronic device 100 is changed when user moves, which might alter the navigation information that leads user to misjudgment. For example, when the wearable electronic device 100, such as a watch, is not worn tightly on outside of a user's wrist, when the user's arm moves or do some gestures, the input/output module 130, such as a screen 130, may be slide to a position that close to palm of the hand, or vertically moved where the screen 130 is positioned inside the user's wrist. Additionally, the viewing angle of the user may be different when the user's arm lifts up to watch the screen 130 every time. In the embodiment, the gravity sensor 110 detects the position of the wearable electronic device 100, and the first navigation information or the second navigation information is converted to the navigation information while the moving direction is changed, so as to reduce misjudgments.

Detailedly speaking, in the embodiment, the gravity sensor 110 is used for sensing a moving direction of the wearable electronic device 100, and the moving direction information is transmitted to the processor 120. The processor 120 converts the first navigation information or the second navigation information to the navigation information according to the sensed moving direction. The input/output module 130 receives the navigation information and further displays it. FIG. 1C is a schematic diagram with another view of FIG. 1B, please both refer to FIG. 1B and FIG. 1C, the display of the navigation information can be cooperated with the viewing angle of the user to allow the user see correct navigation information from different viewing angles.

FIG. 1B and FIG. 1C just shown an image of the navigation information in an embodiment, in other embodiments, the navigation information can include map information 132, if the angle of the map information can be adjusted according to the moving direction and further displayed on the input/output module 130, even without the indication sign, the user also can judge the direction correctly.

The input/output module 130 also is a screen as an example hereinafter. In an embodiment, the wearable electronic device 100 may include a light sensor (not shown), the light sensor can sense ambient light around the input/output module 130. In another embodiment, it can set via the input/output module 130 that when light of the input/output module 130 of the wearable electronic device 100 is insufficient (for example, the input/output module 130 of the wearable electronic device 100 is placed facedown on a table), the input/output module 130 is automatically turned off for power saving, and the navigation information is generated in intermission. When the light sensor senses sufficiency ambient light (such as the input/output module 130 is turned upwards), the input/output module 130 is automatically turned on and displays latest navigation information. As a result, the user does not need to switch the input/output module 130 manually, and it has advantages of power saving and convenience.

When the user has specific usage requirements, he or she can input orders corresponding to the requirements via the input/output module 130. For example, if the user uses the wearable electronic device 100 when the user is in a lying state, the input/output module 130 may slides to some position to make the ambient light around the input/output module 130 insufficient, although the input/output module 130 is preset to be automatically turned off in this condition for power saving, the user also can input an order to make the input/output module 130 continuously turned on, which is not limited herein.

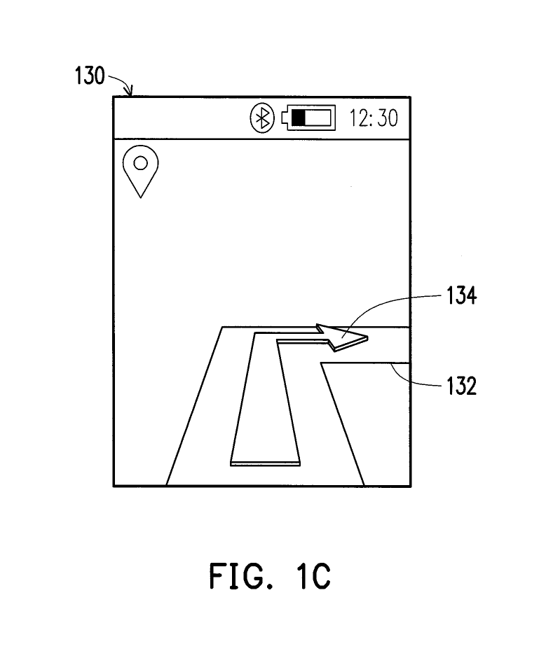

FIG. 2 is a schematic diagram showing a wearable electronic device in an embodiment. Please refer to FIG. 2, the main difference between the wearable electronic device 200 in FIG. 2 and the wearable electronic device 100 in FIG. 1A is that the first navigation information is built in the wearable electronic device 100 in FIG. 1A, In FIG. 2, a second navigation information is stored in an external electronic device 10. The wearable electronic device 200 further includes a first wireless transmission module 250.

In second embodiment, the electronic device 10 is a mobile phone, a tablet computer or a navigator. Since the volume of the electronic device 10 is larger than that of the wearable electronic device 200, it is inconvenient to hold all the time. Thus, the second navigation information stored in the electronic device 10 is transmitted to the wearable electronic device 200 via the first wireless transmission module 250.

In third embodiments, the wearable electronic device 200 is electrically connected to the electronic device 10, and the second navigation information stored in the electronic device 10 is synchronously copied to the wearable electronic device 200, then, the user can get the second navigation information via the wearable electronic device 200.

In the embodiments described above, when the gravity sensor of the wearable electronic device sensing the moving direction, the processor converts the first navigation information or the second navigation information to the navigation information according to the moving direction.

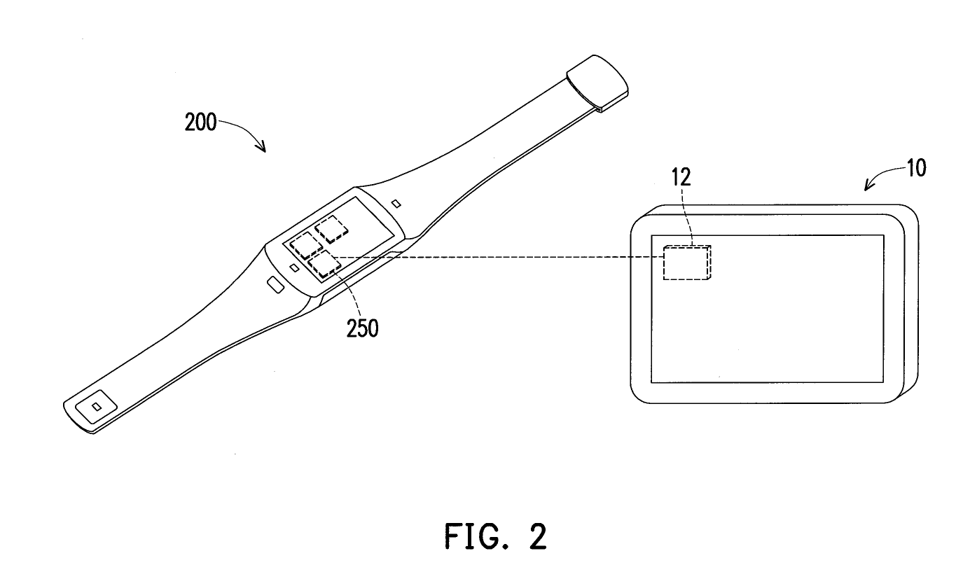

FIG. 3 is a schematic diagram showing a wearable electronic device in an embodiment. Please refer to FIG. 3, the difference between the wearable electronic device 300 in FIG. 3 and the wearable electronic device 100 in FIG. 1A is that the directing information is displayed on the input/output module 130 via an image (such as an indication sign 134) in FIG. 1A, the wearable electronic device 300 in FIG. 3 further includes a loudspeaker 360 electrically connected to a processor 320. The input/output module 330 similarly displays the map information, the processor 320 converts the direction information to voice information, and the loudspeaker 360 plays the voice information that converted from the map information and the directing information. For example, when the directing information shows going straight, turning right or turning left, besides that the input/output module 330 displays the current position of the user, the loudspeaker 360 of the wearable electronic device 300 also makes a sound to remind the user to go straight, turn right or left.

In another embodiment, the input/output module 330 simultaneously displays the map information and the indication sign, and the loudspeaker 360 also makes a sound to remind the user a right route.

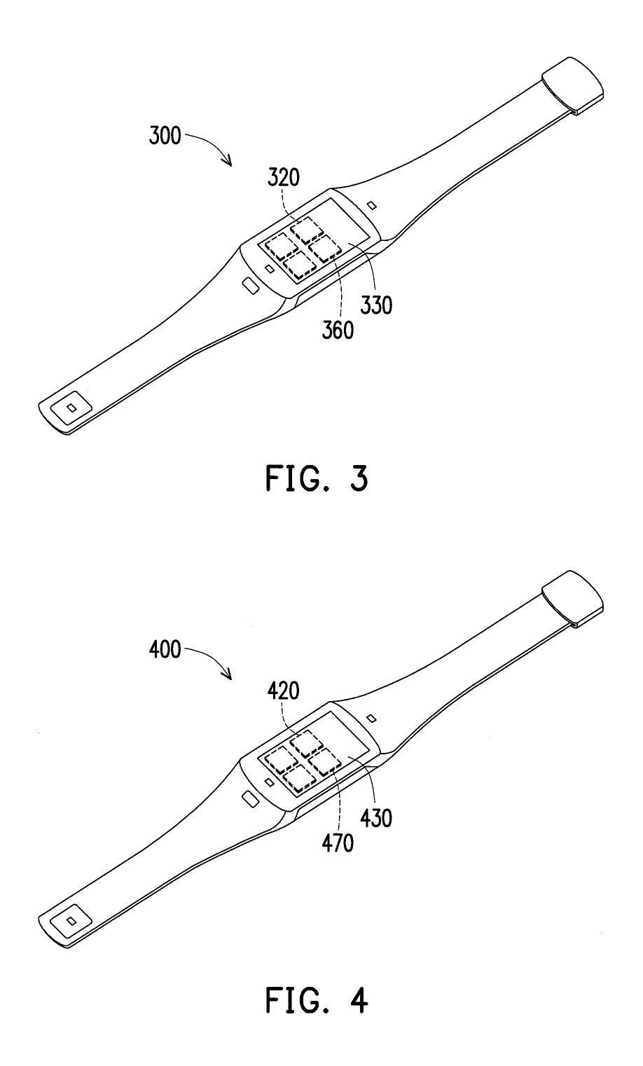

FIG. 4 is a schematic diagram showing a wearable electronic device in an embodiment. Please refer to FIG. 4, the difference between the wearable electronic device 400 in FIG. 4 and the wearable electronic device 100 in FIG. 1A is that the wearable electronic device 400 in FIG. 4 further includes a vibration module 470 electrically connected to a processor 420. The processor 420 converts the map information and the directing information to vibration information, and the vibration module 470 vibrates to indicate a direction.

For example, when the directing information shows turning right or turning left, besides that the input/output module 430 displays the current position of the user, the vibration module 470 of the wearable electronic device 400 vibrates once or twice to remind the user to turn right or turn left, vibration times is not limited herein. In other embodiments, a short vibration represents turning right and a long vibration represents turning left, the vibration mode is not limited herein.

As stated above, multiple applications of a wearable electronic device are provided in embodiments, except for original functions, such as a time display function, an alarm clock function and a decorating function, the wearable electronic device also includes a navigation function. Additionally, the wearable electronic device not only can locate a current position and plan related navigation information according to a destination, a moving direction of the wearable electronic device also can be sensed via a set of a gravity sensor. Thus, a processor can adjust an angle of the first navigation information or the second navigation information to navigation information according to the moving direction, and thus the user can get a right navigation direction even the user changes the gestures, consequently, it can reduce a probability that the user misjudge the navigation information.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A wearable electronic device, comprising:
a gravity sensor, sensing a moving direction of the wearable electronic device;
a processor, electrically connecting to the gravity sensor and generating navigation information according to the moving direction; and
an input/output module electrically connected to the processor to display the navigation information.

2. The wearable electronic device to claim 1, further comprising:
a storage unit for storing a first navigation information and electrically connected to the processor, wherein the navigation information is converted from the first navigation information.

3. The wearable electronic device to claim 1, further comprising:
a first wireless transmission module, a second navigation information stored in an electronic device is transmitted to the wearable electronic device via the first wireless transmission module, wherein the navigation information is converted from the second navigation information.

4. The wearable electronic device to claim 1, wherein the navigation information is tilted according to a change of the moving direction.

5. The wearable electronic device to claim 4, wherein the navigation information further includes map information or directing information, the directing information is converted to an indication sign via the processor, and the indication sign is displayed on the input/output module.

6. The wearable electronic device to claim 5, further comprising:
a loudspeaker electrically connected to the processor, the loudspeaker plays the voice information that converted from the map information or the directing information.

7. The wearable electronic device to claim 5, further comprising:
a vibration module electrically connected to the processor, the vibration module indicates a direction according to vibration information that converted from the map information or the directing information.

8. The wearable electronic device to claim 1, wherein the wearable electronic device includes a watch, a wristband, a pair of glasses or a necklace.

9. The wearable electronic device to claim 1, further comprising:
a light sensor, sensing ambient light around the input/output module.

10. The wearable electronic device to claim 9, wherein the input/output module is automatically turned off under low ambient light, the navigation information is generated in intermission, when the light sensor senses sufficiency ambient light, the input/output module is automatically turned on and displays the latest navigation information.
